(19) United States
(12) Patent Application Publication
(10) Pub. No.: US 2026/0103384 A1
(43) Pub. Date: Apr. 16, 2026

(54) CATALYTIC GRAPHITIZATION OF BAMBOO CHARCOAL FOR SECONDARY BATTERY APPLICATIONS AND ITS PREPARATION PROCESS

(71) Applicant: JEONJU UNIVERSITY OFFICE OF INDUSTRY-UNIVERSITY COOPERATION, Jeonju-si (KR)

(72) Inventors: Hong Gun KIM, Seoul (KR); Seung Kon RYU, Seocheon-gun (KR); Young Soon KIM, Jeonju-si (KR)

(21) Appl. No.: 18/936,670

(22) Filed: Nov. 4, 2024

(30) Foreign Application Priority Data
Oct. 11, 2024 (KR) 10-2024-0138704

(51) Int. Cl. C01B 32/205

(52) U.S. Cl. CPC C01B 32/205; C01P 2002/01; C01P 2002/72; C01P 2002/82; C01P 2002/88; C01P 2006/40

(57) ABSTRACT

Provided are a method for economically preparing graphitized white charcoal having properties suitable for application to separators and electrodes of various batteries at a relatively low temperature, and to graphitized white charcoal prepared by the same.

### CROSS-REFERENCE TO RELATED APPLICATIONS

This application claims the priority of Korean Patent Application No. 10-2024-0138704 filed on Oct. 11, 2024, in the Korean Intellectual Property Office, the disclosure of which is incorporated herein by reference.

### STATEMENT REGARDING PRIOR DISCLOSURES BY THE INVENTOR OR A JOINT INVENTOR

A non-patent literature entitled, “Catalytic Graphitization of Bamboo Charcoal Using Iron Compounds”, which was published on or around Apr. 11-12, 2024, is not a prior art under 35 USC 102 as being a disclosure made directly or indirectly by the inventor or a joint inventor 1 year or less before the effective filing date of the instant application. A copy of the non-patent literature prior disclosure is being submitted with the instant application in an Information Disclosure Statement pursuant to 37 CFR 1.97 and 1.98.

### BACKGROUND

### Field

The present disclosure relates to a method for economically preparing graphitized white charcoal having properties suitable for application to separators and electrodes of various batteries at a relatively low temperature, and to graphitized white charcoal prepared by the same.

### Description of the Related Art

Graphite is one of main materials used in separators and various electrodes of batteries, and is prepared by mixing a refined graphite reinforcing material with a polymer binder. Recently, attempts have been made to improve the performance of separators and electrodes by adding carbon nanotubes or graphene, which are crystalline carbon, to a main binder, graphite, thereby increasing properties such as strength and conductivity. However, the need for an economical method for preparing the graphite is gradually increased due to issues such as expensive material prices.

Graphite has the ability to insert lithium ions at low voltages and thus has been mainly used as a cathode material for lithium-ion batteries, but among graphite, synthetic graphite (SG) has an advantage of being able to easily control quality to reach standards and obtain a desired shape, but has a disadvantage of being more expensive than natural graphite (NG).

Highly crystalline graphite may be obtained by first treating synthetic graphite (SG) at a temperature of about 1,500° C. and then treating the synthetic graphite at a high temperature of 2,500 to 3,000° C., and the natural graphite (NG) is mined in geographically limited areas and then refined and prepared through a process of using large amounts of chemicals and energy after mining. In both production processes for synthetic graphite and natural graphite as described above, a high-temperature heating process is included, which has a problem of requiring high energy consumption and environmental costs.

Meanwhile, charcoals have the characteristic that a carbon structure thereof consists of microcrystals similar to graphite and an amorphous part surrounding the microcrystals, but through a graphitization process by applying high-temperature heat treatment to these charcoals, the charcoals may be transformed into a graphitized charcoal form with a regular three-dimensional graphite structure to prepare graphitized charcoals. The heat treatment process for preparing graphitized charcoals typically involves a process of applying high-temperature heat of approximately 2,400° C. to 3,000° C. to transform the structure of the charcoals.

Charcoals are broadly classified into black charcoal and white charcoal depending on a method of firing in the kiln. The black charcoal is black in color when fired at a temperature of 600 and 700° C. and has a fixed carbon content of about 70 to 80%. The black charcoal is light, crumbles easily, and often exhibits slightly alkaline properties. The white charcoal is prepared by firing at a temperature of about 1,000° C. and is characterized by a slightly white shell and a fixed carbon content of approximately 90%. The white charcoal is heavy, hard, and slightly acidic.

Korean Patent Registration No. 10-2566246 discloses a method for preparing graphite crystalline white charcoal using common oak white charcoal as a raw material, but uses a high temperature of 1,500° C. and 2,400° C. during heat treatment. Even in Korean Patent Publication No. 10-2022-0117649, a process of preparing highly crystalline artificial graphite using non-graphitizable carbons (charcoal, biomass, etc.) includes a heat treatment step at 1,200° C. to 2,100° C., so that there is the need for high-temperature heat and energy input to prepare all graphitized carbons.

Accordingly, the present inventors continued research to obtain graphitic carbon having higher crystallinity even when heated at a relatively low temperature range than a high temperature conditions pointed out as a problem of a conventional graphite preparing method, and as a result, completed the present disclosure relating to a method for preparing graphitized white charcoal without high-temperature heat treatment by using white charcoal made from bamboo, which has a hollow carbon nanotube-shaped structure and thus has a well-oriented axial tissue in a layered structure, unlike conventional charcoal raw materials such as oak tree.

### SUMMARY

In a conventional preparation technology for preparing graphitized charcoal having a graphite crystal structure using charcoal, a heat treatment process of about 2,400° C. or higher is included not only to require high energy, but also to require high-temperature auxiliary facilities such as a graphite furnace and expensive sweep gases such as argon. Accordingly, there is a problem of being uneconomical in terms of production efficiency and cost.

An object of the present disclosure is to provide a method for preparing graphitized white charcoal having structural and functional characteristics of graphite even when a charcoal raw material (white charcoal) is heat treated at a relatively low temperature.

In addition, another object of the present disclosure is to provide graphitized white charcoal prepared by the preparation method.

In order to achieve one object of the present disclosure, according to an aspect of the present disclosure, a method for preparing graphitized white charcoal may include a fine-pulverization step of pulverizing bamboo white charcoal with a pulverizer; a catalyst metal impregnation step of immersing the fine-pulverized white charcoal in a catalyst metal solution; a carbonization step of heating the white charcoal impregnated with the catalyst metal at a temperature of 300 to 400° C. in a nitrogen atmosphere; and a graphitization step of heating the carbonized white charcoal at a temperature of 900 to 1,200° C. in a nitrogen atmosphere. At this time, the catalyst metal solution may be a solution in which at least one catalyst metal selected from the group consisting of a transition metal salt, transition metal carbon, and aluminum alkoxide is dissolved in water or alcohol.

According to another aspect of the present disclosure, there is provided graphitized white charcoal prepared according to the preparation method.

According to the method for preparing the graphitized white charcoal of the present disclosure, graphitized white charcoal is prepared by heating bamboo white charcoal as a raw material at temperatures of 300 to 400° C. and 900 to 1,200° C., and thus, compared to conventional methods for preparing graphite carbon using raw materials such as charcoal, which include high-temperature heat treatment, the method consumes relatively less energy and is economical in terms of manufacturing facilities and costs.

In addition, generally, in a process of preparing graphitized charcoal, argon and expensive sweep gases are used, or other additional materials need to be used as raw materials. However, the method for preparing graphitized white charcoal of the present disclosure has an advantage of having no need to use raw materials requiring additional costs because the reaction is performed under a nitrogen atmosphere.

Furthermore, as described above, even though graphitized white charcoal is prepared under relatively low temperature conditions and without using expensive sweep gases, the preparing method of the present disclosure has an effect of being able to prepare graphitized white charcoal with excellent quality having properties such as graphitization and crystallinity, which are suitable for use as separators and electrodes of various batteries, artificial diamond, or the like.

However, the effects of the present disclosure are not limited to the above-mentioned effects, and other effects not mentioned will be clearly understood by those skilled in the art from the following description.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a process diagram schematically illustrating a method for preparing graphitized white charcoal of the present disclosure;

FIGS. 2A-2D show thermal analysis results using a thermogravimetric analyzer (TGA) performed to analyze the characteristics of graphitized white charcoal prepared by a method for preparing graphitized white charcoal according to an example of the present disclosure for each process step. FIG. 2A illustrates a TGA result of raw bamboo white charcoal used as a raw material, FIG. 2B illustrates a TGA result of white charcoal immersed in a catalyst metal solution to be impregnated with metal, FIG. 2C illustrates a TGA result of carbonized white charcoal after a carbonization step, and FIG. 2D illustrates a TGA result of graphitized white charcoal prepared after a graphitization step;

FIGS. 3A-3D show XRD analysis results of X-ray diffraction analysis performed on white charcoal for each process step of the method for preparing graphitized white charcoal of the present disclosure described in FIG. 2. The description of analysis targets in FIGS. 3A to 3D is the same as that described in FIGS. 2A-2D;

FIGS. 4A-4D show results of Raman spectroscopy analysis performed on white charcoal for each process step of the method for preparing graphitized white charcoal of the present disclosure described in FIG. 2. The description of analysis targets in FIGS. 4A to 4D is the same as that described in FIGS. 2A-2D;

FIG. 5 is a result of isothermal adsorption/desorption curve analysis performed on white charcoal for each process step of the method for preparing graphitized white charcoal of the present disclosure described in FIGS. 2A-2D to confirm their adsorption characteristics. The description of analysis targets in FIGS. 5A to 5D is the same as that described in FIGS. 2A-2D; and

FIGS. 6A and 6B illustrate transmission electron microscope (TEM) results of observing structures of graphitized bamboo white charcoal (Example, FIG. 6B) using bamboo as a raw material and prepared according to the method for preparing graphitized white charcoal of the present disclosure, and graphitized oak white charcoal (Comparative Example, FIG. 6A) using oak as a raw material and prepared according to a conventional method for preparing graphitized white charcoal.

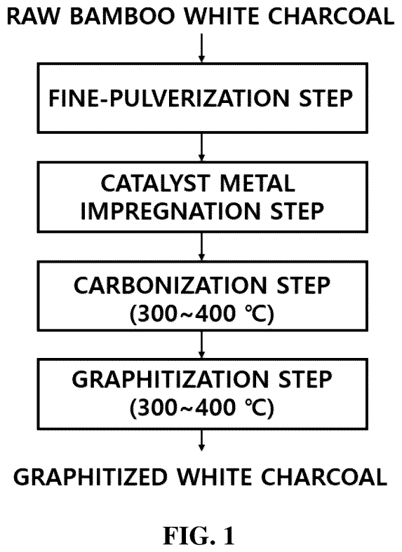

### DETAILED DESCRIPTION OF THE EMBODIMENT

Hereinafter, the present disclosure will be described in detail.

An aspect of the present disclosure provides a method for preparing graphitized white charcoal.

The method for preparing graphitized white charcoal includes a fine-pulverization step of pulverizing bamboo white charcoal with a pulverizer; a catalyst metal impregnation step of immersing the fine-pulverized white charcoal in a catalyst metal solution; a carbonization step of heating the white charcoal impregnated with the catalyst metal at a temperature of 300 to 400° C. in a nitrogen atmosphere; and a graphitization step of heating the carbonized white charcoal at a temperature of 900 to 1,200° C. in a nitrogen atmosphere. The catalyst metal solution is a solution in which at least one catalyst metal selected from the group consisting of a transition metal salt, transition metal carbon, and aluminum alkoxide is dissolved in water or alcohol.

In the present disclosure, the term ‘white charcoal’ refers to a type of charcoal that is made by heating at a higher temperature than black charcoal among the charcoals that are produced by removing moisture and impurities through carbonization due to incomplete combustion of wood.

The white charcoal used in the method for preparing graphitized white charcoal of the present disclosure is white charcoal made using bamboo as a raw material, and may be used with white charcoal prepared according to a conventional method for preparing white charcoal.

The bamboo white charcoal may be white charcoal produced at a temperature of 800° C. or higher, 900° C. or higher, or 1,000° C. or higher.

For example, the bamboo white charcoal may be prepared by putting bamboo wood in a kiln and heating the wood to a temperature in the same range, and more specifically, may be prepared through a refining process to improve the quality of charcoal at a high temperature by injecting air into the kiln in a step where the carbonization of charcoal is completed and re-burning gas generated when bamboo was decomposed. The charcoal in the condition may be taken out of the kiln and covered with ash, etc., and then the fire extinguished to prepare white charcoal. At this time, the ash may stick to the surface of the charcoal to represent a grayish white color.

The bamboo white charcoal may have a fixed carbon content of 90% or more, 92% or more, 95% or more, or 96% or more. The bamboo white charcoal may have a higher carbon content than oak white charcoal, and the wood thereof is hard and strong so as not to catch easily, but may have a property to burn for a long time after catching the fire.

In the method for preparing graphitized white charcoal according to an example of the present disclosure, the bamboo white charcoal used as a raw material may be produced at a temperature of about 1,000° C. and have a fixed carbon content of about 92%.

The fine-pulverization step may be pulverizing bamboo white charcoal using a fluid energy mill or ball mill, but is not limited thereto.

The fine-pulverization step may include passing the pulverized bamboo white charcoal pulverized using the pulverizer described above through a standard sieve. At this time, the standard sieve may be, for example, a standard sieve of 320 mesh, 325 mesh, 330 mesh, 350 mesh, 400 mesh or 450 mesh or more, and accordingly, the passed fine-pulverized white charcoal may be fine-pulverized to have the particle size of 44 μm or less.

The catalyst metal impregnation step is to immerse the fine-pulverized white charcoal in a solution in which a compound such as a transition metal salt, a transition metal carbon compound, a metal carbon compound, aluminum alkoxide, metal acetylacetonate, and/or an organometallic complex is dissolved. The catalyst metal solution may be a solution in which the catalyst metal is dissolved in water or alcohol, specifically, methyl alcohol, ethyl alcohol, isopropyl alcohol, etc., but is not limited thereto.

The transition metal may be iron (Fe), cobalt (Co), nickel (Ni), manganese (Mn), ruthenium (Ru), platinum (Pt), etc., but is not limited thereto.

The transition metal salt may be Fe(NO₃)₃·9H₂O and/or NiCl₂·6H₂O, but is not limited thereto.

The transition metal carbon compound may be a carbide in which transition metal and carbon are combined, specifically Fe₃C, and more specifically austenite, cementite, perlite, and/or ferrite, but is not limited thereto.

The metal carbon compound may be Al₄C₃, but is not limited thereto.

The aluminum alkoxide may be Al(OR₁)₃, wherein R₁ may be methyl, ethyl, n-propyl, etc., but is not limited thereto, and for example, the aluminum alkoxide may be aluminum-triisopropoxide (Al-triisopropoxide).

The metal acetylacetonate may be Al(acac)₃, Fe(acac)₃, Co(acac)₂, Zr(acac)₄, TiO(acac)₂, Y(acac)₃·9H₂O, etc., but is not limited thereto.

As the catalyst metal impregnation step is performed, catalyst particles in the catalyst metal solution may be impregnated into micropores of the fine-pulverized white charcoal, and in the subsequent carbonization and graphitization steps, the thermal decomposition and graphitization processes of white charcoal may be promoted by the impregnated catalyst particles. If the catalyst metal impregnation step as described above is not performed, graphite crystals may not develop even after processes are performed according to the conditions (particularly, temperature conditions) of subsequent steps of the present disclosure.

The method for preparing graphitized white charcoal of the present disclosure may further include washing and drying the solution in which the white charcoal is immersed after the impregnation step.

The washing and drying may be performed by filtering the catalyst metal solution in which the fine-pulverized white charcoal is immersed, washing the filtrate with distilled water, etc., and drying the filtrate by applying heat. At this time, the drying may be performed at a temperature of 90 to 120° C., for example, 105° C., for 15 hours or more, for example, 24 hours, but is not limited thereto.

The carbonization step may be heating for 10 to 15 hours, 11 to 14 hours, or 12 to 13 hours, but is not limited thereto.

The graphitization step may be heating for 1 to 2 hours, 1 hour and 30 minutes to 2 hours, or 1 hour to 1 hour and 30 minutes, but is not limited thereto.

After the carbonization step and/or graphitization step, the white charcoal may have a carbon-metal atomic layer deposition (ALD) formed on the surface thereof.

The method for preparing graphitized white charcoal of the present disclosure may further include a catalyst metal removal step of treating acid or applying heat after the graphitization step.

The acid may be specifically hydrochloric acid, sulfuric acid, nitric acid, etc., and more specifically hydrochloric acid, but is not limited thereto.

The method for preparing graphitized white charcoal of the present disclosure may further a washing and drying step after the catalyst metal removal step.

The washing and drying may be performed by washing the acid-treated white charcoal at least once with distilled water and drying the white charcoal at room temperature for at least 10 hours, at least 15 hours, or at least 24 hours, but is not limited thereto.

Another aspect of the present disclosure provides graphitized white charcoal.

The graphitized white charcoal is prepared according to the method for preparing graphitized white charcoal of the present disclosure.

The graphitized white charcoal has excellent crystallinity so that graphite crystals are grown, and thus has properties suitable for use as separators or electrodes for various batteries, and may have properties similar to complete graphite.

The graphitized white charcoal may have an interlayer distance of 0.335 nm to 0.360 nm, 0.340 nm to 0.355 nm, or 0.343 nm to 0.345 nm, but is not limited thereto, and may have an interlayer distance similar to that of complete graphite or a similar crystal structure thereto.

The graphitized white charcoal may adsorb a nitrogen amount of 1 cc/g to 2 cc/g, 1.2 cc/g to 1.8 cc/g, 1.3 to 1.5 cc/g, or 1.4 cc/g, but is not limited thereto.

The surface area of the graphitized white charcoal may be 8 m²/g to 9 m²/g, 8.2 m²/g to 8.8 m²/g, 8.4 m²/g to 8.6 m²/g, or 8.45 m²/g, but is not limited thereto and may have a value similar to the specific surface area value of complete graphite.

Another aspect of the present disclosure provides an electrode for a secondary battery.

The electrode for a secondary battery includes the graphitized charcoal of the present disclosure.

The graphitized charcoal of the present disclosure has properties suitable for use in a secondary battery electrode, and thus can be usefully used as a secondary battery material.

Hereinafter, the present disclosure will be described in detail by Examples and Experimental Examples.

However, the following Examples and Experimental Examples are just illustrative of the present disclosure in detail, and the contents of the present disclosure are not limited to the following Examples and Experimental Examples.

### EXAMPLE

### Preparation of White Charcoal According to Method for Preparing Graphitized White Charcoal of the Present Disclosure

Bamboo white charcoal was pulverized using a fluid energy mill or ball mill and sieved to pass through a standard sieve of 325 mesh (<44 μm) and classified. The bamboo white charcoal was used with bamboo white charcoal produced at a temperature of about 1,000° C.

A catalyst metal solution was prepared by dissolving Fe(acac)₃ in an alcohol solution, and the fine-pulverized bamboo white charcoal as described above was added to the catalyst metal solution, and stirred at 80 to 100 rpm at room temperature for 24 hours. Through this process, free Fe metal in the solution may be impregnated into the micropores of the fine-pulverized bamboo white charcoal. The white charcoal to which Fe metal was impregnated was filtered, washed several times with distilled water, and then dried at room temperature for 24 hours.

Then, the white charcoal was carbonized by heating in a nitrogen atmosphere at a temperature of 300 to 400° C. for 10 to 15 hours, and then graphitized by heating in a nitrogen atmosphere at a temperature of 900 to 1,200° C. for 1 to 2 hours to prepare graphitized white charcoal.

Thereafter, the prepared graphitized white charcoal was added in a hydrochloric acid solution of an appropriate concentration (0.1 M to 0.5 M) and stirred at 80 to 100 rpm to completely remove a metal atomic layer deposition formed on the surface of the white charcoal, washed several times with distilled water, and then dried at room temperature for 24 hours. The graphitized white charcoal prepared as described above was used in various subsequent analysis experiments.

### Experimental Example

### Comparative Analysis of Graphitized Oak White Charcoal and Graphitized White Charcoal of the Present Disclosure

Various characteristics of graphitized bamboo white charcoal prepared according to the preparing method of the present disclosure were analyzed through various methods.

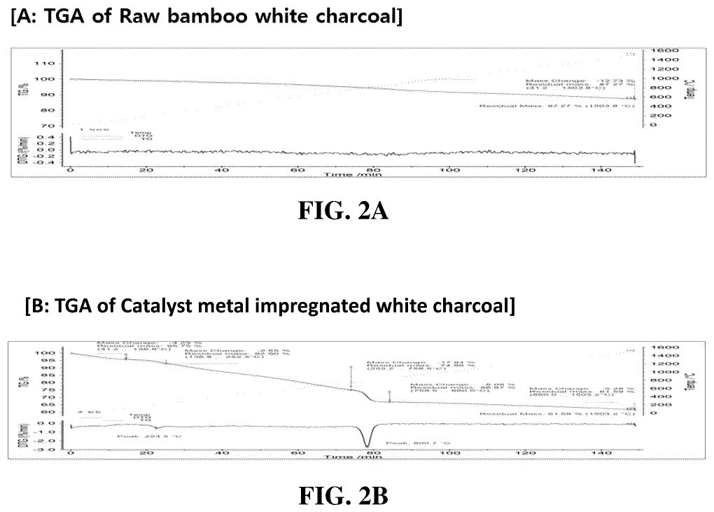

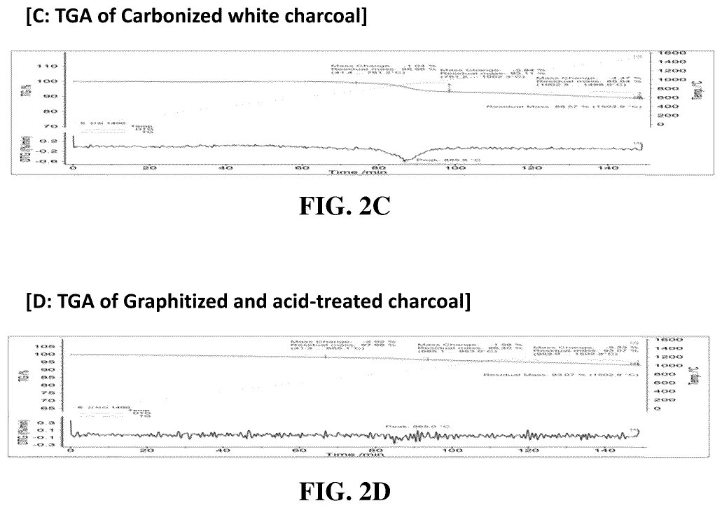

First, thermogravimetric (TG) characteristics for each process step were confirmed through thermal analysis using a thermogravimetric analyzer (TGA) according to the process, which were shown in FIGS. 2A-2D. The mass of a sample to a temperature or time was analyzed according to a temperature change of the sample by applying heat to the sample, and the analysis was performed on raw bamboo white charcoal used as a raw material (FIG. 2A), white charcoal immersed in a catalyst metal solution to be impregnated with metal (FIG. 2B), carbonized white charcoal after a carbonization step (FIG. 2C), and graphitized white charcoal prepared after a graphitization step (FIG. 2D). As a result of the analysis, the graphitized bamboo white charcoal prepared according to the preparing method of the present disclosure showed a very high yield of 87.27% even when heat-treated at up to 1,500° C. Through the results, it could be proven that the method of the present disclosure was an economical preparing method for preparing the graphitized white charcoal.

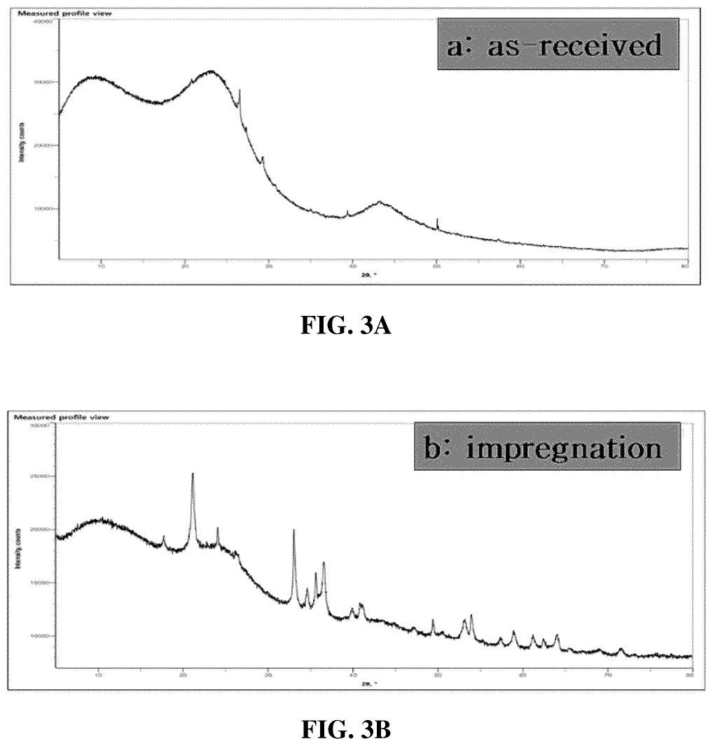

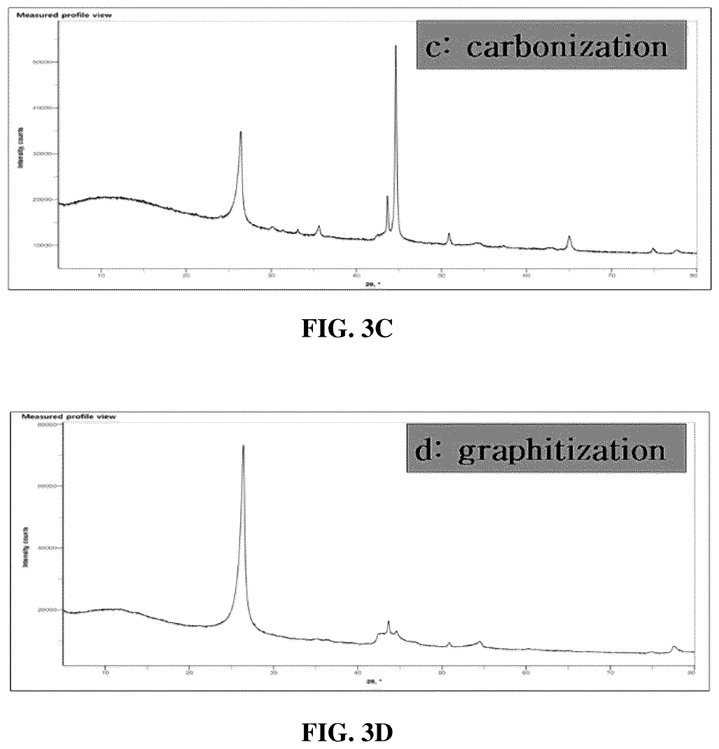

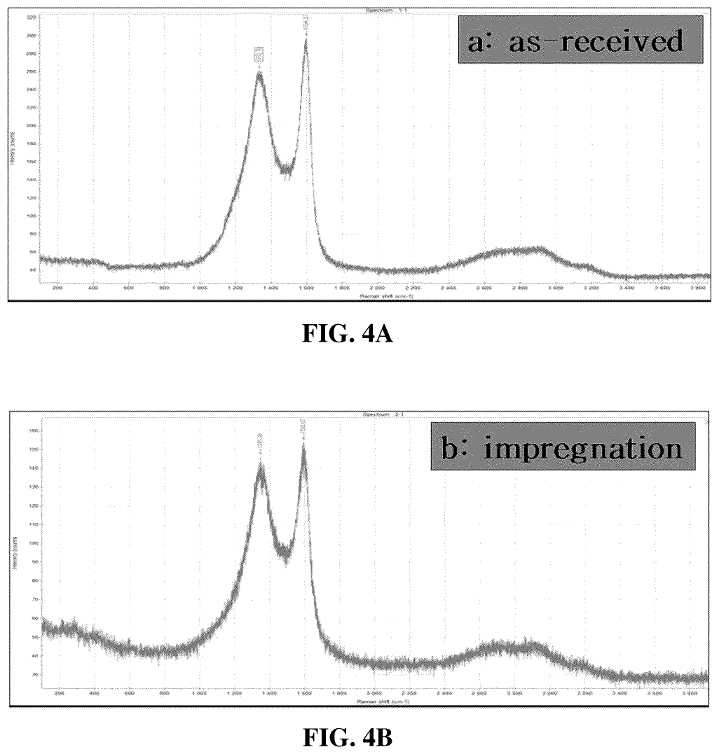

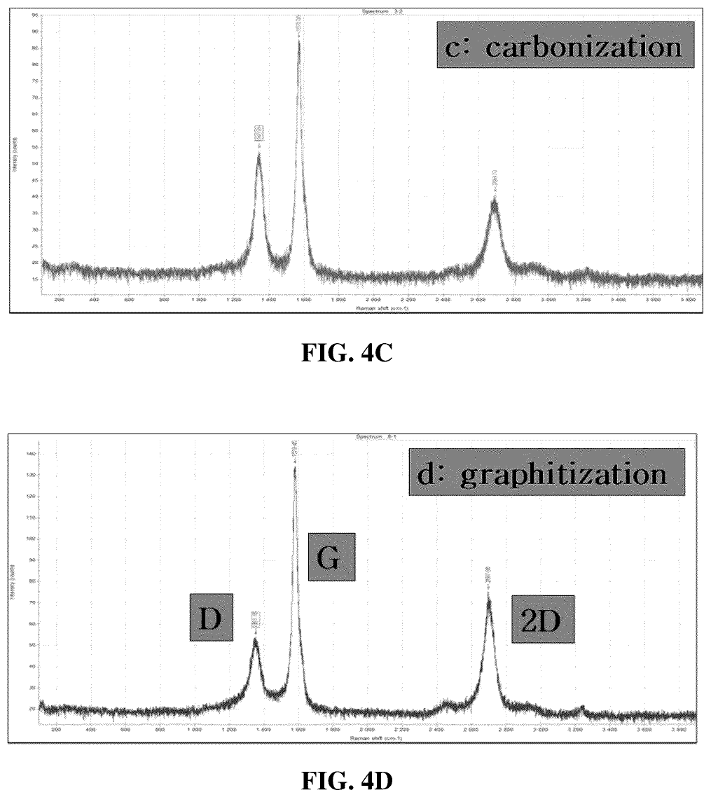

After the thermogravimetric analysis, in order to analyze each characteristic according to the process of the graphitized white charcoal of the present disclosure, similarly, X-ray diffraction analysis was performed on raw bamboo white charcoal used as a raw material, white charcoal immersed in a catalyst metal solution to be impregnated with metal, carbonized white charcoal after a carbonization step, and graphitized white charcoal prepared after a graphitization step, and then the XRD analysis results were shown in FIGS. 3A-3D, and Raman spectroscopy analysis was performed and then the results were shown in FIGS. 4A-4D.

In the XRD diffraction analysis results, in the case of raw bamboo white charcoal, no sharp peak indicating crystal growth appeared when 2θ was 26.5 cm⁻¹ (FIG. 3A). However, since the graphitized white charcoal of the present disclosure prepared after the graphitization step showed a clear peak when 2θ was 26.5 cm⁻¹ (FIG. 3D), it was confirmed that graphitized crystals grew as a result of preparing the graphitized white charcoal according to the preparing method of the present disclosure.

In the Raman spectroscopy results, in the case of raw bamboo white charcoal, a sp² bond double scattering 2D band suggesting graphitization crystals did not appear at 2,680 cm⁻¹ (FIG. 4A). In contrast, in the case of the graphitized white charcoal of the present disclosure prepared after the graphitization step, not only a clear 2D band appeared, but also it was shown that the graphitized crystals have grown well because the height of a D band was much lower than a G band (FIG. 4D).

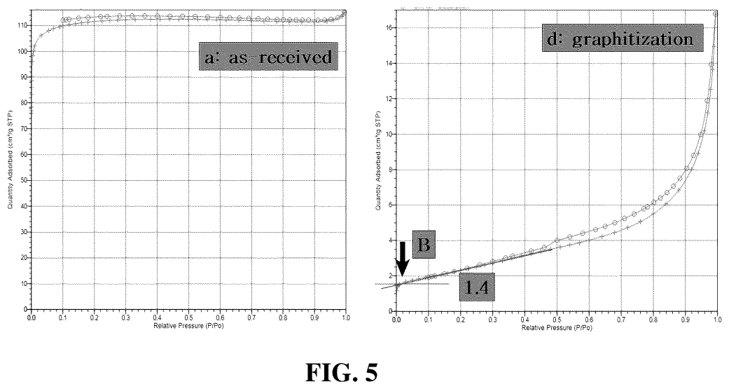

In addition, in order to confirm the adsorption characteristics of the graphitized white charcoal of the present disclosure, the characteristics for each process step were confirmed through isothermal adsorption/desorption curve analysis. Nitrogen adsorption was analyzed at a temperature of 77 K for raw bamboo white charcoal used as a raw material and graphitized white charcoal prepared after the graphitization step. As a result, the raw bamboo white charcoal appeared in the form of Type I (micropore) with countless micropores on the surface, which indicated low relative pressure hysteresis (FIG. 5A), and the graphitized white charcoal prepared after the graphitization step appeared in the typical form of Type II (non-porous) of graphitized bamboo white charcoal (FIG. 5D). Point B, indicated by an arrow in FIG. 5D, was a starting point when drawing a tangent line at a bent part (knee) of the isothermal adsorption/desorption curve, and an intercept value of a horizontal line drawn herein of 1.4 corresponds to a monolayer value of the sample. That is, the graphitized bamboo white charcoal of the present disclosure may have the characteristic of adsorbing 1.4 cc/g of nitrogen, and at this time, the surface area corresponds to 8.45 m²/g, so that the graphitized white charcoal of the present disclosure may exhibit characteristics very similar to the specific surface area value of complete graphite.

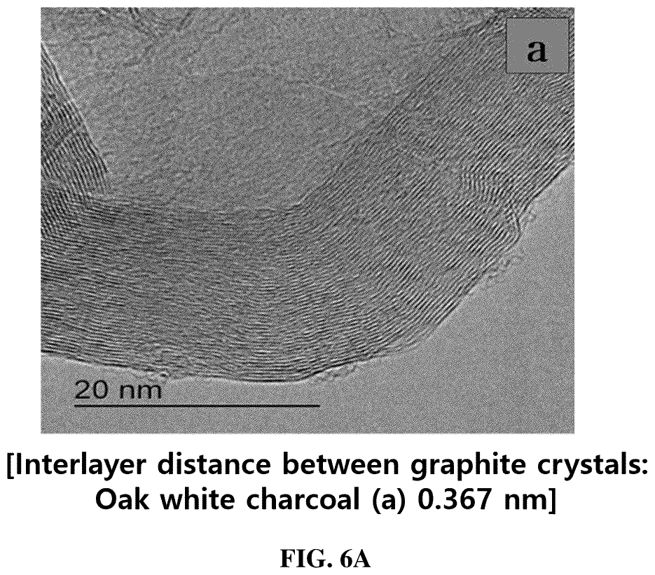

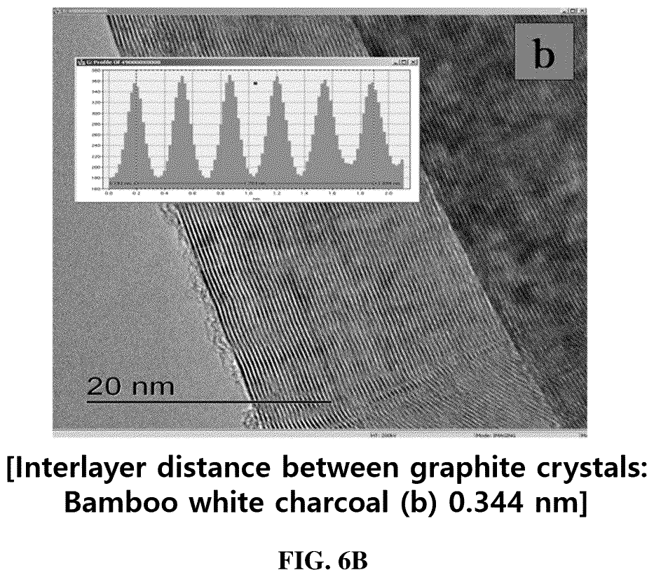

Furthermore, structural differences were compared and analyzed between graphitized oak white charcoal (Comparative Example) prepared by heating at a temperature of 2,400° C. or higher according to a conventional method for preparing graphitized white charcoal and graphitized bamboo white charcoal of Example of the present disclosure. To this end, each graphitized white charcoal was confirmed using a transmission electron microscope (TEM) and interlayer distances between these graphite crystals were measured (FIGS. 6A and 6B). As a result of the measurement, the interlayer distance between the graphite crystals of the oak white charcoal in Comparative Example was measured as 0.367 nm, while the interlayer distance between the graphite crystals of the bamboo white charcoal in Example was measured as 0.344 nm. Therefore, there is a difference therebetween. The interlayer distance of the graphitized bamboo white charcoal prepared according to the preparing method of the present disclosure was found to be close to a theoretical graphite interlayer distance (Lc=0.334 to 0.335 nm) to have high crystallinity.

When graphite has a perfect structure, an interlayer distance thereof was 0.334 to 0.335 nm, but in many cases, the graphite had a structurally twisted graphite-like structure (turbostratic structure, etc.). In the case of charcoal, the structure thereof is different from that of graphite, and thus, due to such a structural difference, it is difficult to obtain a complete graphite structure even if charcoal is graphitized. White charcoal prepared by heat-treating oak charcoal at a high temperature of 2,400° C. according to a conventional method for preparing graphitized charcoal (Comparative Example) had a structure in which the interlayer distance was 0.367 nm. However, graphitized white charcoal prepared by catalytic graphitization of bamboo charcoal according to the present disclosure had an interlayer distance of 0.344 nm, thereby obtaining a graphite-like structure.

Therefore, the preparing method of the present disclosure has an advantage of being able to obtain graphitized white charcoal even with heat treatment at a relatively low temperature in terms of economic efficiency, and an effect of high preparing yield, and has a superior effect to conventional technologies in terms of a structure capable of obtaining graphitized white charcoal having a similar graphite structure that may be used for the same use as graphite.

As described above, while the present disclosure has been described in detail with reference to the described embodiments, it is apparent to those skilled in the art that various modifications and changes may be made within the technical idea of the present disclosure, and it is natural that these modifications and changes belong to the appended claims.

What is claimed is:

1. A method for preparing graphitized white charcoal comprising:
a fine-pulverization step of pulverizing bamboo white charcoal with a pulverizer;
a catalyst metal impregnation step of immersing the fine-pulverized white charcoal in a catalyst metal solution;
a carbonization step of heating the white charcoal impregnated with the catalyst metal at a temperature of 300 to 400° C. in a nitrogen atmosphere; and
a graphitization step of heating the carbonized white charcoal at a temperature of 900 to 1,200° C. in a nitrogen atmosphere,
wherein the catalyst metal solution is a solution in which at least one compound selected from the group consisting of a transition metal salt, a transition metal carbon compound, a metal carbon compound, a metal acetylacetonate, aluminum alkoxide, and an organometallic complex is dissolved in water or alcohol.

2. The method for preparing graphitized white charcoal of claim 1, wherein the bamboo white charcoal has a fixed carbon content of 90% or more.

3. The method for preparing graphitized white charcoal of claim 1, further comprising:
washing and drying the solution in which the white charcoal is immersed after the catalyst metal impregnation step.

4. The method for preparing graphitized white charcoal of claim 1, further comprising:
a catalyst metal removal step of treating acid or applying heat after the graphitization step.

5. The method for preparing graphitized white charcoal of claim 4, further comprising:
washing and drying after the catalyst metal removal step.

6. The method for preparing graphitized white charcoal of claim 1, wherein in the fine-pulverization step, the bamboo white charcoal is fine-pulverized to 44 μm or less.

7. The method for preparing graphitized white charcoal of claim 1, wherein the transition metal salt is at least one selected from the group consisting of Fe(NO₃)₃·9H₂O and NiCl₂·6H₂O.

8. The method for preparing graphitized white charcoal of claim 1, wherein the transition metal carbon compound is at least one selected from the group consisting of austenite, cementite, perlite, and ferrite.

9. The method for preparing graphitized white charcoal of claim 1, wherein the carbonization step is heating for 10 to 15 hours.

10. The method for preparing graphitized white charcoal of claim 1, wherein the graphitization step is heating for 1 to 2 hours.

11. Graphitized white charcoal prepared according to the preparation method of claim 1.

12. The graphitized white charcoal of claim 11, wherein
an interlayer distance is 0.335 nm to 0.360 nm.

13. An electrode for a secondary battery comprising the graphitized charcoal of claim 11.
